(19) United States
(12) Patent Application Publication
(10) Pub. No.: US 2006/0072206 A1
(43) Pub. Date: Apr. 6, 2006

(54) Image display apparatus and image display system

(76) Inventors: Takashi Tsuyuki, Kawasaki-shi (JP); Naosato Taniguichi, Saitama-shi (JP)

Correspondence Address: MORGAN & FINNEGAN, L.L.P., 3 WORLD FINANCIAL CENTER, NEW YORK, NY, 10281-2101, US

(21) Appl. No.: 11/240,925

(22) Filed: Sep. 29, 2005

(30) Foreign Application Priority Data
Oct. 1, 2004 (JP) 2004-290086

(51) Int. Cl. G02B 27/14

(52) U.S. Cl. 359/631

(57) ABSTRACT

An image display apparatus enabling a wearer to observe an image free from a sense of incongruity is disclosed. This image display apparatus has an image forming unit for forming a first image and a second image mutually having a parallax, a first optical unit for guiding the first image to a first eye, a second optical unit for guiding the second image to a second eye, an interval changing portion for changing an interval between the first optical unit and the second optical unit and a signal output portion for outputting a signal corresponding to the interval to an image generating portion which generates the first and second images.

### BACKGROUND OF THE INVENTION

1. Field of the Invention

The present invention relates to an image display apparatus for displaying a first image and a second image mutually having a parallax.

2. Related Background Art

A conventional head mounted display apparatus (HMD) is provided with an interpupillary distance adjustment mechanism for conformity to the interpupillary distance of an observer in order to solve problems such as uncomfortableness and unlikeliness of fusion, etc. at the time of mounting for use.

As an interpupillary distance adjustment mechanism, in an image display apparatus using a liquid crystal panel, a mechanism of electrically adjusting the display area within a displayable area of the liquid crystal panel (see, for example, Japanese Patent Application Laid-Open No. H09-271043) and a mechanism that has been made to enable a user to adjust the display positions mechanically (see, for example, Japanese Patent Application Laid-Open No. H06-315121) are present.

In addition, Japanese Patent Application Laid-Open No. H09-271043 proposes a technique for adjusting the interpupillary distance by shifting a display area corresponding to a parallax image displayed in a display device.

However, the above described conventional display apparatus adjusts only the interpupillary distance and does not display an image in conformity to the interpupillary distance. Thereby, there exists a difference in vision between in a case where an observer usually takes a look without using the head mounted display apparatus and in a case of using the head mounted display apparatus. Consequently, the head mounted display apparatus will give an observer who wears it a sense of incongruity and give a fatigued feeling as a result of fusion becoming unlikely to take place on the left and right images.

Here, in case of using a head mounted display apparatus for displaying Mixed Reality and Virtual Reality, it is necessary to alleviate as much as possible a sense of incongruity of the difference in vision between in the case of using a head mounted display apparatus and in the case of not using it. In particular, in case of displaying Mixed Virtual Reality, it is necessary to display a parallax image in conformity to the interpupillary distance of an observer in order to emphasize a sense of reality derived by the way of vision similar to that in case of human eyes viewing the real space.

### SUMMARY OF THE INVENTION

The image display apparatus as an example of the present invention has an image forming unit for forming a first image and a second image mutually having a parallax, a first optical unit for leading the above described first image to a first eye, a second optical unit for leading the above described second image to a second eye, an interval changing portion for changing an interval between the above described first optical unit and the above described second optical unit, and a signal output portion for outputting a signal corresponding to the above described interval to an image generating portion of generating the above described first and second images.

### BRIEF DESCRIPTION OF THE DRAWINGS

FIG. 1 is a block diagram showing a configuration of an image display system being Embodiment 1 of the present invention;

FIG. 2 shows a top view (A) and a front view (B) of an interpupillary distance adjuster in Embodiment 1;

FIG. 3 is a flow chart showing interpupillary distance adjusting operations in Embodiment 1;

FIG. 4A shows an interpupillary distance adjustment pattern;

FIG. 4B shows a state of discrepancy in an interpupillary distance adjustment pattern;

FIG. 5 is a block diagram showing a configuration of an image display system being Embodiment 2 of the present invention;

FIG. 6 is a block diagram showing a configuration of an image display system being Embodiment 3 of the present invention;

FIG. 7 shows a top view (A) and a front view (B) of an interpupillary distance adjuster in Embodiment 3; and

FIG. 8 is a flow chart showing interpupillary distance adjusting operations in Embodiment 3.

### DETAILED DESCRIPTION OF THE PREFERRED EMBODIMENTS

Embodiments of the present invention will be described as follows.

### Embodiment 1

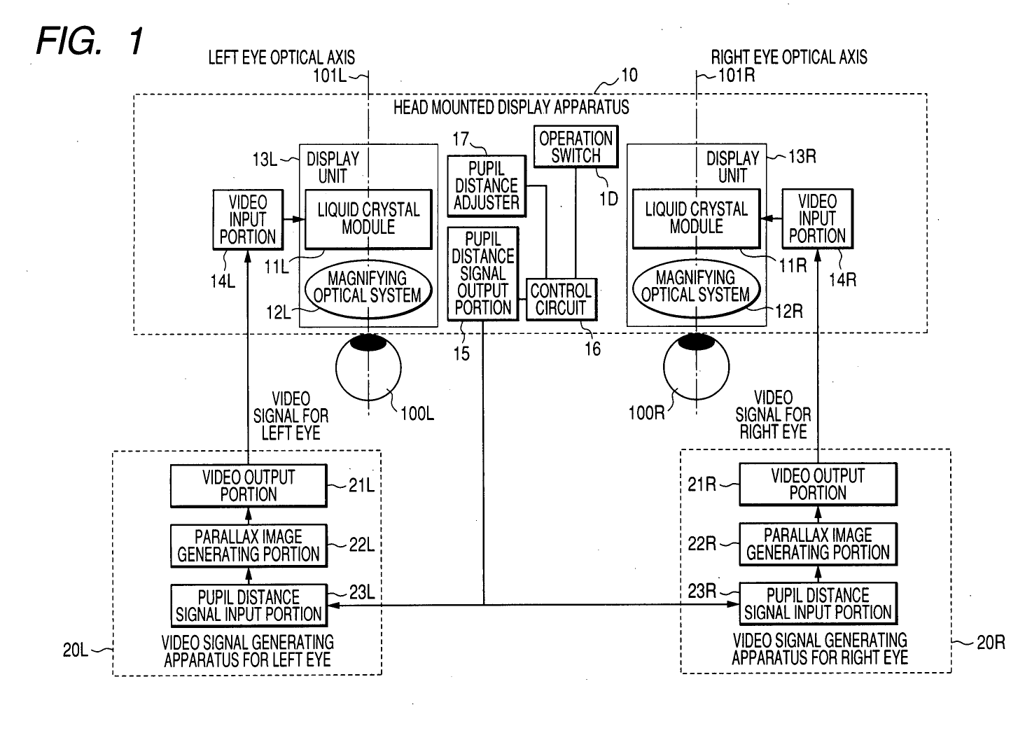

FIG. 1 is a block diagram showing a configuration of an image display system having a head mounted display apparatus being Embodiment 1 of the present invention, and a video signal generating apparatus for outputting video signals to the head mounted display apparatus.

The head mounted display apparatus 10 has display units 13R and 13L for a right eye 100R and for a left eye 100L, an interpupillary distance adjuster (interval changing portion) 17, an interpupillary distance signal output portion (signal output means) 15, video input portions 14R and 14L, a control circuit (a circuit using a microcomputer etc.) 16 and an operation switch 1D.

The display units 13R and 13L respectively have liquid crystal modules (image forming elements) 11R and 11L as display devices and magnifying optical systems (first and second optical units) 12R and 12L of magnifying the displayed images in the liquid crystal modules 11R and 11L.

The magnifying optical systems 12R and 12L reflect light from the liquid crystal modules 11R and 11L a plurality of times and thereafter emit light to eyes of a person who wears the head mounted display apparatus 10. Thereby, the wearer of the HMD can observe a displayed image in the liquid crystal modules 11R and 11L in a magnified state.

Here, the interpupillary distance in the head mounted display apparatus 10 refers to an interval between optical axes (emission optical axes) 101R and 101L of the magnifying optical systems 12R and 12L. The operation switch 1D is operated when the interpupillary distance in the head mounted display apparatus 10 is adjusted as described later.

The liquid crystal modules 11R and 11L respectively have liquid crystal panels such as p-SiTFT and LCOS etc., peripheral circuits (drive circuits etc.) thereof and light sources (back light and front light).

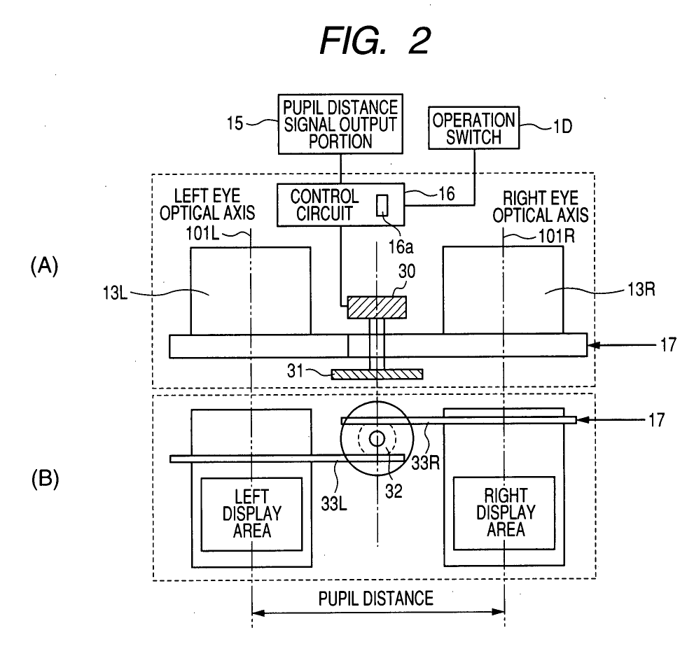

The interpupillary distance adjuster 17 moves display units 13R and 13L in directions perpendicular to the optical axes 101R and 101L (horizontal directions, leftward or rightward directions in FIG. 1) corresponding to operations of the wearer. The configuration of the interpupillary distance adjuster 17 is shown in (A) and (B) of FIG. 2. Here, FIG. 2 shows a top view (A) and a front view (B) of a configuration of an interpupillary distance adjuster.

In (A) and (B) of FIG. 2, display units 13R and 13L are respectively provided with racks 33R and 33L and the racks 33R and 33L engage with a gear (pinion gear) 32. And, the gear 32 is brought into connection with an adjustment control 31 that is rotated/operated by the wearer and a rotary encoder 30 that rotates together with the gear 32.

In the configuration of the above described interpupillary distance adjuster 17, when a wearer rotates the adjustment control 31, the display units 13R and 13L move in the mutually opposite directions at the same distance. That is, when the adjustment control 31 is rotated in one direction, the display units 13R and 13L move in mutually approaching directions so that the interpupillary distance in the head mounted display apparatus 10 is narrowed. On the other hand, when the adjustment control 31 is rotated in the other direction, the display units 13R and 13L move in the, mutually departing directions so that the interpupillary distance in the head mounted display apparatus 10 is widened.

The rotary encoder 30 detects rotary angles of the adjustment control 31 to output this detected outcome to the control circuit 16.

In a memory 16a inside the control circuit 16, a data table showing the relationship between the rotary angle of the adjustment control 31 and the interpupillary distance is stored. The control circuit 16 specifies, from the data table inside the memory 16a, interpupillary distance data corresponding to rotary angle data from the rotary encoder 30. And, the control circuit 16 outputs the specified interpupillary distance data to an interpupillary distance signal output portion 15.

That is, the control circuit 16 reads, as electric signals, an interval (interpupillary distance) between an optic axes 101R and 101L adjusted by operations of the interpupillary distance adjuster 17 via the rotary encoder 30 to output this read interpupillary distance data to the interpupillary distance signal output portion 15.

Here, the present embodiment described the case where the data table indicating the relationship between the rotary angle data of the adjustment control 31 and the interpupillary distance data was stored in the memory 16a in advance, however, the interpupillary distance data may be derived by calculation from the rotary angle data.

The interpupillary distance signal output portion 15, which is configured by an interface driver IC such as RS232C, USB, IEEE1394 and the like, outputs the above described interpupillary distance data to the video signal generating apparatuses 20R and 20L respectively for a right eye and a left eye.

The video signal generating apparatuses 20R and 20L are configured by, for example, a general-purpose computer. And the video signal generating apparatuses 20R and 20L have the interpupillary distance signal input portions 23R and 23L, the parallax image generating portions 22R and 22L and the video output portions 21R and 21L.

The interpupillary distance data from the interpupillary distance signal output portions 15 of the head mounted display apparatus 10 is inputted to the interpupillary distance signal input portions 23R and 23L and the inputted interpupillary distance data is outputted to the parallax image generating portions 22R and 22L. The interpupillary distance signal input portions 23R and 23L are configured the same as the interpupillary distance signal output portion 15 of the head mounted display apparatus 10, and are configured by interfaces such as the RS232C, USB and IEEE1394 etc.

The video signal generating portions 22R and 22L generate parallax images for a right eye and for a left eye based on the inputted interpupillary distance data. The video signal generating portions 22R and 22L operate in accordance with a software program.

The video output portions 21R and 21L output the parallax image generated in the video signal generating portions 22R and 22L to the video input portions 14R and 14L inside the head mounted display apparatus 10. Here, for example, a graphic card equipped in a computer functions as the video output portions 21R and 21L.

The present embodiment described the case where the video signal generating apparatuses 20R and 20L and the head mounted display apparatus 10 were configured as separate bodies, but these apparatuses 20R, 20L and 10 may be configured integrally.

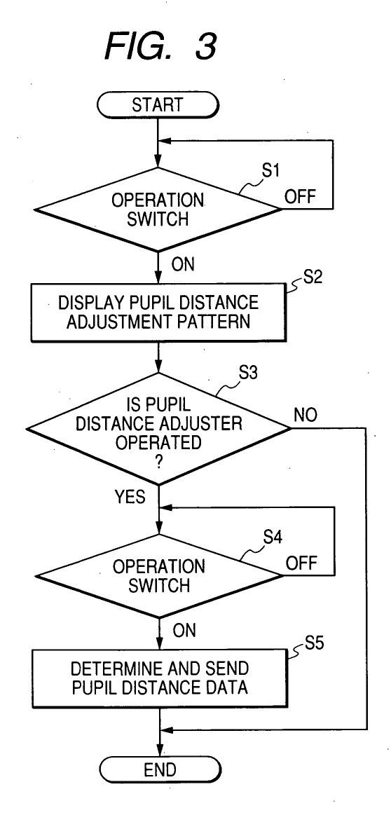

Next, interpupillary distance adjusting operations in the image display system of the present embodiment will be described with reference to a flow chart shown in FIG. 3.

An interpupillary distance and parallax image adjusting mode follows Step S1 when the operation switch 1D is switched ON.

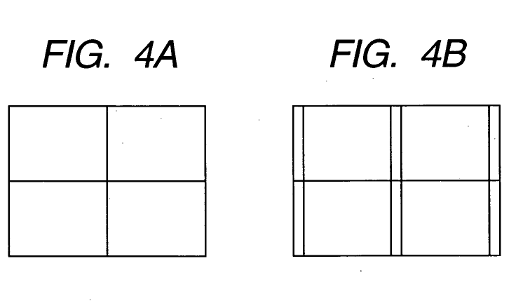

In Step S2, the liquid crystal modules 11R and 11L display, for example, an interpupillary distance adjustment pattern shown in FIG. 4A. Specifically, the control circuit 16 notifies the video signal generating apparatuses 20R and 20L of that the state has entered the interpupillary distance and parallax image adjusting mode through the interpupillary distance signal output portion 15 and transmits a command of causing the interpupillary distance adjustment pattern to be displayed. The video signal generating apparatuses 20R and 20L in receipt of this command generate, in the parallax image generating portions 22R and 22L, an interpupillary distance adjustment pattern shown in FIG. 4A and cause the liquid crystal modules 11R and 11L of the head mounted display apparatus 10 to display it.

A wearer of the head mounted display apparatus 10 adjusts the interpupillary distance by operating the adjustment control 31 of the interpupillary distance adjuster 17 so that an image (interpupillary distance adjustment pattern) displayed with the liquid crystal modules 11R and 11L appears in an overlapped and fused state. Here, the adjustment control 31 is operated so that the interpupillary distance adjustment pattern appears substantially in accord with the case where the interpupillary distance adjustment pattern appears with a positional error as shown in FIG. 4B.

In Step S3, the control circuit 16 determines whether or not the adjustment control 31 is operated based on an output of the rotary encoder 30, and in case of in operation, Step S4 follows and in case of not in operation, the present flow is over.

In the case where the interpupillary distance adjustment pattern appears substantially in accord at last subject to wearer's operation of the adjustment control 31, he/she operates the operation switch 1D again.

Step S4 judges whether or not the operation switch 1D is switched ON, and in an ON state, Step S5 follows.

In Step S5, the control circuit 16 determines the interpupillary distance data based on the rotary angle data at the point of time when the operation switch 1D is switched ON in Step S4 as well as on the data table in the memory 16a. In addition, the interpupillary distance data is outputted to the video signal generating apparatuses 20R and 20L via the interpupillary distance output portion 15 Thereby, adjustment of the interpupillary distance in the head mounted display apparatus 10 is completed.

And, in case of causing the head mounted display apparatus 10 to display an observation image, the parallax image generating portions 22R and 22L generate parallax images for a left eye and for a right eye based on the inputted interpupillary distance data to output these generated images to the head mounted display apparatus.

According to the image display system of the present embodiment, a wearer can observe a parallax image without a sense of incongruity since the parallax image is generated corresponding to the interpupillary distance of a head mounted display apparatus 10, and a fatigued feeling while observing the image can be alleviated. Moreover, an image with high reality can be observed.

Here, the present embodiment has so far described the case where the interpupillary distance data is determined from the rotary angle data of the adjustment control 31 detected by operations of the interpupillary distance adjuster 17 to transmit the interpupillary distance data to the video signal generating apparatuses 20R and 20L, and can be configured as described below.

That is, the head mounted display apparatus may be provided with a pupil detecting unit for detecting pupil positions of the wearer to calculate the interpupillary distance of the wearer based on the pupil positions detected by the pupil detecting unit and to transmit these interpupillary distance data to the video signal generating apparatus.

### Embodiment 2

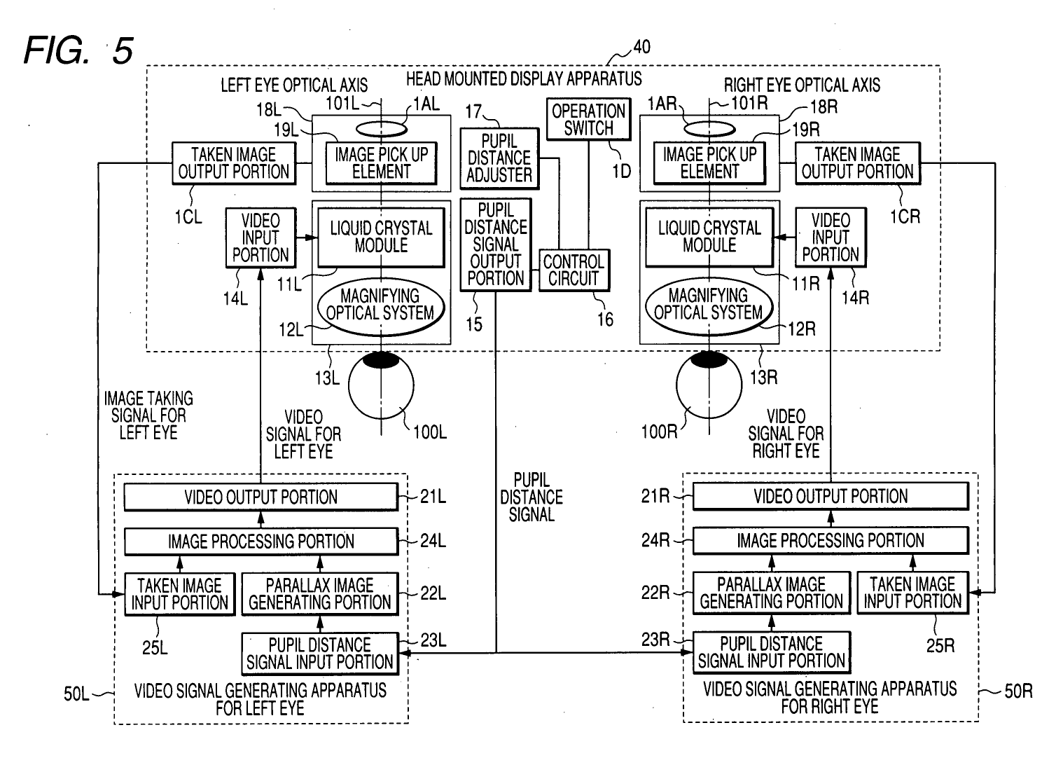

FIG. 5 shows a configuration of an image display system being Embodiment 2 of the present invention. In FIG. 5, like reference numerals designate the same members as the members described in Embodiment 1, and detailed descriptions will be omitted.

A head mounted display apparatus in an image display system of the present embodiment relates to Mixed Reality and is a head mounted display apparatus of a video see-through type which has an image taking optical system and a display optical system.

The head mounted display apparatus 40 of the present embodiment has image pickup units (first and second image pickup means) 18R and 18L as well as taken image output portions 1CR and 1CL in addition to the configuration of a head mounted display apparatus of Embodiment 1.

The image pickup units 18R and 18L respectively have image pickup elements 19R and 19L such as a CMOS sensor and a CCD sensor, drive circuits (not shown) for driving image pickup elements 19R and 19L and image pickup lenses 1AR and 1AL.

Optical images (object images) are formed on image pickup surfaces of the image pickup elements 19R and 19L by the image pickup lenses 1AR and 1AL and the optical images undergo photoelectric conversion with the image pickup elements 19R and 19L to be converted to electric signals. The output signals of the image pickup elements 19R and 19L are inputted to the taken image input portions 25R and 25L of the video signal generating apparatuses 50R and 50L through the taken image output portions 1CR and 1CL.

On the other hand, likewise Embodiment 1, the output signals (interpupillary distance data) of the interpupillary distance signal output portion 15 is inputted to the interpupillary distance signal input portions 23R and 23L of the video signal generating apparatuses 50R and 50L and parallax images corresponding to the interpupillary distance data are generated in the parallax image generating portions 22R and 22L.

The image processing portions 24R and 24L synthesize parallax images from the parallax image generating portions 22R and 22L and taken images from the taken image input portions 25R and 25L to output the synthesized images to the head mounted display apparatus 40 (video input portions 14R and 14L) via the video output portions 21R and 21L.

Here, the image processing portions 24R and 24L operate in accordance with a software program on a computer at a rapid processing speed. In addition, the taken image output portions 1CR and 1CL can be configured by rapid interfaces such as USB 2.0 and IEEE1394 which are applicable to videos and are installed in computers. Moreover, the taken image input portions 25R and 25L can be configured, likewise the taken image output portions 1CR and 1CL, by rapid interfaces such as USB 2.0 and IEEE1394 which are installed in computers.

The liquid crystal modules 11R and 11L display taken images as well as parallax images in an overlapped state. Thereby, a video see-through type head mounted display apparatus 40 is configured.

With the head mounted display apparatus of a video see-through type, a wearer can observe object images (external environment images) taken by the image pickup units 18R and 18L as well as the parallax images through the display units 13R and 13L as described above.

Here, the image pickup units 18R and 18L and the display units 13R and 13L are disposed so that the photographing optical axes (central axes of the photographing areas) 102R and 102L of the image pickup units 18R and 18L (photographing lenses 1AR and 1AL) substantially correspond to the optical axes 101R and 101L of the display units 13R and 13L (magnifying optical systems 12R and 12L).

Adopting such an arrangement, a parallax between the wearer's line of sights (optical axes 101R and 101L) and the line of sights (photographing optical axes) in the image pickup units 18R and 18L can be approximately eliminated and the observation state where the head mounted display apparatus is mounted can be made to be approximately the same as a state where it is not mounted.

Here, the image pickup unit 18R may be arranged to the display unit 13R so that the photographing optical axis 102R is perpendicular to a plane including the optical axes 101R and 101L and is located within the plane including the optical axis 101R. Likewise, the image pickup unit 18L may be arranged to the display unit 13L so that the photographing optical axis 102L is perpendicular to a plane including the optical axes 101R and 101L and is located within the plane including the optical axis 101L.

In addition, in case of adjusting the interpupillary distance at the head mounted display apparatus 40 with operations of the interpupillary distance adjuster 17, the display units 13R and 13L as well as the image pickup units 18R and 18L can move integrally. That is, by the operations of the adjustment control 31 (see (A) and (B) of FIG. 2) of the interpupillary distance adjuster 17, the display unit 13R as well as the image pickup unit 18R and the display unit 13L as well as the image pickup unit 18L move in the mutually opposite directions.

Also in the present embodiment, operations of the interpupillary distance adjuster 17 can adjust the interpupillary distance at the head mounted display apparatus and therefore effects as in Embodiment 1 can be derived. In particular, in the present embodiment, the state with actual space and virtual space being overlapped each other can be observed without a sense of incongruity.

Here, in the present embodiment, a head mounted display apparatus of a video see-through type was explained, however, the present embodiment is also applicable to a so-called head mounted display apparatus of an optical see-through type which overlaps actual space viewed directly with a half mirror.

### Embodiment 3

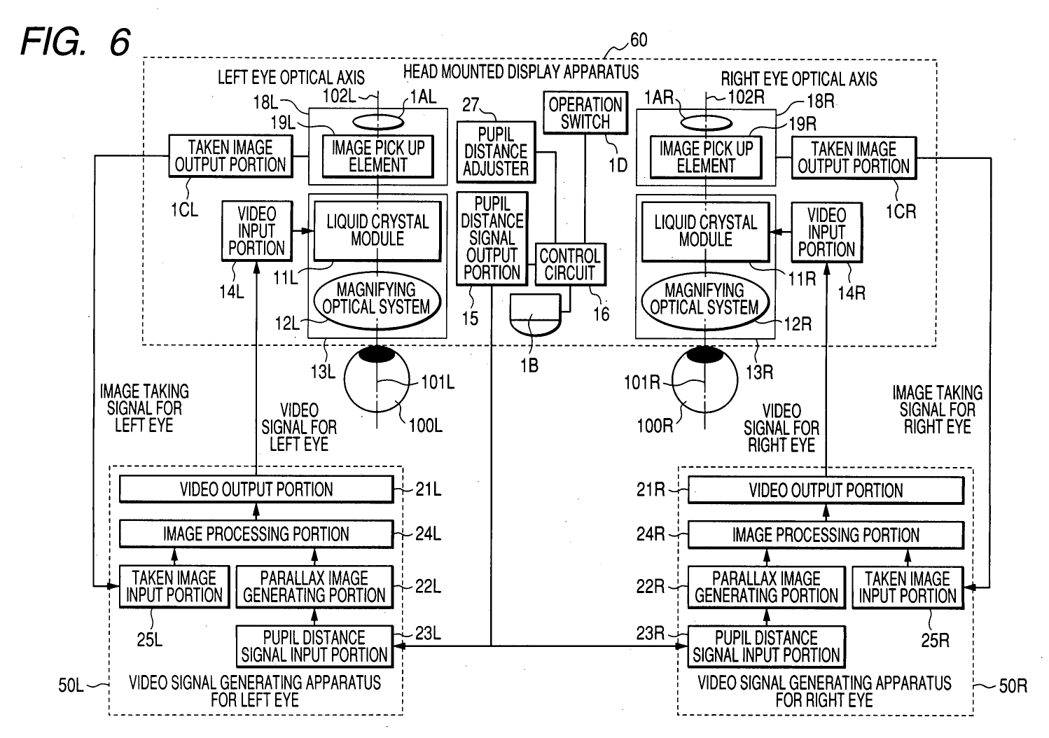

FIG. 6 shows a configuration of an image display system being Embodiment 3 of the present invention. In FIG. 6, like reference numerals designate the same members as the members described in Embodiments 1 and 2, and detailed descriptions will be omitted.

In Embodiments 1 and 2, a wearer operates an interpupillary distance adjuster so as to adjust the interpupillary distance at the head mounted display apparatus. On the other hand, a head mounted display apparatus 60 in the present embodiment detects wearer's interpupillary distance so as to adjust the interpupillary distance at the head mounted display apparatus 60 automatically based on this detected outcome.

In addition to the configuration of a head mounted display apparatus of Embodiment 2, the head mounted display apparatus 60 of the present embodiment has a pupil detecting unit (interpupillary distance detecting means) 1B for detecting wearer's pupil positions. The pupil detecting unit 1B can be configured by an infrared camera unit of wide view angle including, for example, a floodlight element irradiating an infrared light, a fish-eye lens and an image pickup element.

That is, the floodlight element irradiates an infrared light to the wearer's both eyes so that both eyes respectively undergo image pickup with an image pickup element. And, a image processing operation circuit (not shown) in the pupil detecting unit 1B detects the pupil positions, for example, the center positions of both ends in the black eye areas of the eyes to calculate, from the pupil positions, the wearer's interpupillary distance.

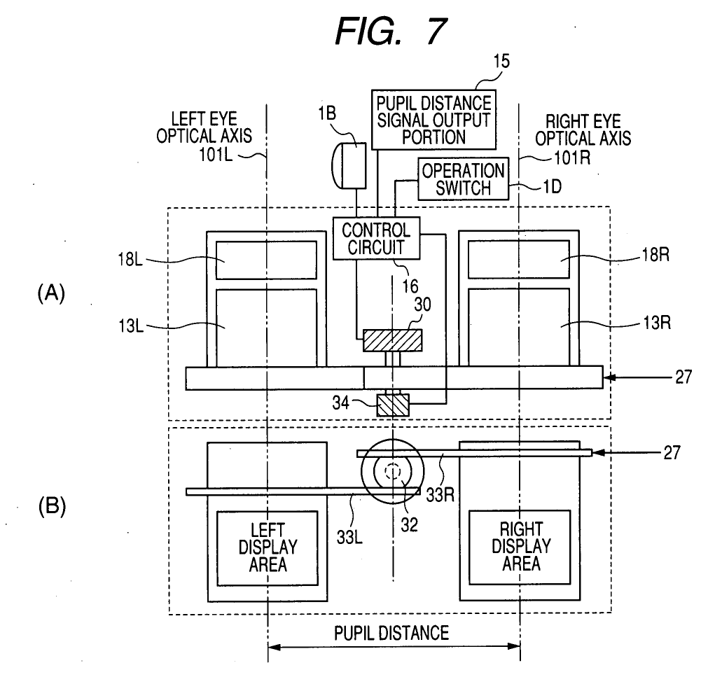

Next, such a configuration that the interpupillary distance adjuster 27 adjusts the interpupillary distance at the head mounted display apparatus 60 based on the wearer's interpupillary distance data calculated by the above described interpupillary detecting operations will be described with reference to (A) and (B) of FIG. 7. Here, FIG. 7 shows a top view (A) and a front view (B) showing a portion of the head mounted display apparatus of the present embodiment.

An interpupillary distance adjuster 27 has a rack 33R brought into connection with a display unit 13R as well as an image pickup unit 18R, a rack 33L brought into connection with a display unit 13L as well as an image pickup unit 18L and a gear 32 with which the racks 33R and 33L engage.

An output axis of the motor (drive means) 34 is brought into connection with the gear 32, the gear 32 rotates when a drive signal is inputted from the control circuit (drive means) 16 to the motor 34, and thereby the racks 33R and 33L that engage with the gear 32 move. Thereby, the display units 13R and 13L move in the mutually opposite directions so that the interpupillary distance at the head mounted display apparatus 60 can be changed.

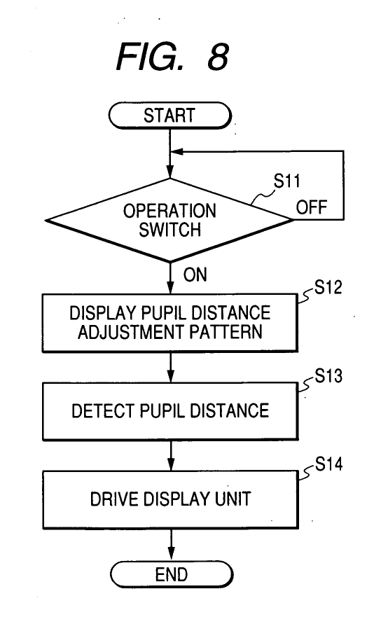

Next, interpupillary distance adjusting operations in the head mounted display apparatus of the present embodiment will be described with reference to a flow chart shown in FIG. 8.

An interpupillary distance and parallax image adjusting mode follows Step S11 when the operation switch 1D is switched ON.

In Step S12, the liquid crystal modules 11R and 11L display an interpupillary distance adjustment pattern. Specifically, the control circuit 16 notifies the video signal generating apparatuses 50R and 50L of the change of the state of having entered the interpupillary distance and parallax image adjusting mode through the interpupillary distance signal output portion 15, and transmits a command for displaying the interpupillary distance adjustment pattern.

The video signal generating apparatuses 50R and 50L in receipt of this command generate, in the parallax image generating portions 22R and 22L, an interpupillary distance pattern and causes the liquid crystal modules 11R and 11L of the head mounted display apparatus 60 to display it. Here, causing the interpupillary distance adjustment pattern to include a predetermined indicator, the wearer's eyes can be fixed on the indicator.

In Step S13, the wearer's pupil positions are detected by the pupil detecting unit 1B as described above. Data on the detected pupil positions is outputted to the control circuit 16.

In Step S14, the control circuit 16 calculates the wearer's interpupillary distance based on the pupil position data to control the drive of the motor 34 based on this interpupillary distance data. That is, the control circuit 16 drives the motor 34 while it monitors the rotary angle of the gear 34 based on the output of the rotary encoder 30.

And, using a data table stored in a memory 16a of the control circuit 16, in the case where the rotary angle under monitoring reaches a rotary angle corresponding to the interpupillary distance data calculated in advance, the drive of the motor 34 is stopped. And, the present flow is over.

Thereby, the interpupillary distance at the head mounted display apparatus can be caused to substantially correspond to the wearer's interpupillary distance.

Here, in the present embodiment, the case where the motor 34 was used was described, however, as proposed in the above described Japanese Patent Application Laid-Open No. H09-271043, using a display element having wider display area than the actual display area as the liquid crystal modules 11R and 11L, the position of the actual display area can be changed within the displayable area in accordance with the interpupillary distance data. In addition, the pupil detecting unit 1B can be provided so as to correspond to either the right eye or the left eye or both of them.

According to the present embodiment, since the interpupillary distance at the head mounted display apparatus 60 is adjusted automatically, it can save the wearer's trouble of manually adjusting the interpupillary distance at the head mounted display apparatus 60, and images free from a sense of incongruity can be observed.

This application claims priority from Japanese Patent Application No. 2004-290086 filed Oct. 1, 2004, which is hereby incorporated by reference herein.

What is claimed is:

1. An image display apparatus, comprising:
an image forming unit for forming a first image and a second image mutually having a parallax;
a first optical unit for guiding the first image to a first eye;
a second optical unit for guiding the second image to a second eye;
an interval changing portion for changing an interval between said first optical unit and said second optical unit, the interval changing portion mechanically connected to the first optical unit and the second optical unit; and
a signal output portion for outputting a signal corresponding to the interval to an image generating portion for generating the first and second images.

2. The image display apparatus according to claim 1, wherein when changing said interval by said interval changing potion, said image forming unit forms an image for adjusting the interval.

3. The image display apparatus according to claim 1, further comprising:
an interpupillary distance detecting portion for deriving the distance between said first eye and said second eye; and
an actuator for driving said interval changing portion corresponding to the distance.

4. The image display apparatus according to claim 1, further comprising:
a first image pickup portion for taking a third image to be overlapped on said first image; and
a second image pickup portion for taking a fourth image to be overlapped on said second image,
wherein centers of image pickup regions in the first and second image pickup portions are located respectively on a first plane that is perpendicular to separating directions of said first and second optical units and includes an optical axis of said first optical unit and on a second plane that is perpendicular to the separating directions and includes an optical axis of said second optical unit.

5. An image display apparatus, comprising:
an image forming unit for forming a first image and a second image mutually having a parallax;
a first optical unit for guiding the first image to a first eye;
a second optical unit for guiding the second image to a second eye;
an interval changing portion for changing an interval between the first optical unit and the second optical unit, the interval changing portion mechanically connected to the first optical unit and the second optical unit;
an interpupillary distance detecting portion for deriving a distance between the first eye and the second eye; and
a signal output portion for outputting a signal corresponding to the distance to an image generating portion which generates the first and second images.

6. An image display system, comprising:
the image display apparatus according to claim 1; and
an image generating apparatus for generating, from signals outputted from said signal output portion, said first and second images having a parallax corresponding to said interval and for supplying the image display apparatus with the first and second images having a parallax corresponding to the interval.

7. An image display system, comprising:
the image display apparatus according to claim 5; and
an image generating apparatus for generating, from signals outputted from said signal output portion, said first and second images having a parallax corresponding to said distance and for supplying the image display apparatus with the first and second images having a parallax corresponding to the distance.
